(19) United States
(12) Patent Application Publication
(10) Pub. No.: US 2019/0326771 A1
(43) Pub. Date: Oct. 24, 2019

(54) HAND-HELD POWER TOOL SYSTEM

(71) Applicant: Robert Bosch GmbH, Stuttgart (DE)

(72) Inventor: Juergen Mack, Goeppingen (DE)

(21) Appl. No.: 16/470,907

(22) PCT Filed: Dec. 8, 2017
(86) PCT No.: PCT/EP2017/082017

§ 371 Date: Jun. 18, 2019

(30) Foreign Application Priority Data
Dec. 21, 2016 (DE) 102016225730.7

(51) Int. Cl. H02J 7/04; H02J 7/02; B25F 5/00; H02J 50/10

(52) U.S. Cl. CPC H02J 7/047; H02J 50/10; B25F 5/00; H02J 7/025

(57) ABSTRACT

A hand-held power tool system encompassing a hand-held power tool, a rechargeable battery pack, a charging device, a temperature sensor, an interface for electrically and/or mechanically coupling the charging device to the rechargeable battery pack to be charged, and a control unit for controlling the charging process. The system includes a heater for heating the charging device and/or the rechargeable battery pack, and the control unit being configured for receiving a temperature signal of a temperature sensor. The temperature signal represents a temperature of the charging device and/or of the rechargeable battery pack and/or of rechargeable battery cells in the rechargeable battery pack. The control unit compare the transmitted temperature to a predefined threshold value and heats the charging device and/or the rechargeable battery pack before the start of the charging process using the heater when the temperature transmitted via the temperature signal is below the predefined threshold value.

### FIELD

The present invention relates to a hand-held power tool system.

### BACKGROUND INFORMATION

Electrical hand-held power tools, such as, for example, impact screwdrivers, drills, angle grinders, jigsaws, circular saws or planers for use by skilled workers or do-it-yourselfers usually include either an AC motor or a DC motor as the drive motor. While the former is generally supplied with AC current from the power supply network via a power cord, the electrical energy for supplying the DC motor generally originates from a so-called rechargeable battery pack, a rechargeable accumulator in a housing which is coupleable to the housing of the hand-held power tool and which is electrically connected to the power supply lines of the DC motor when the two housings are coupled.

Such conventional rechargeable battery packs often include rechargeable accumulators, generally a plurality of battery cells connected in a parallel and/or series circuit. As part of this application, a rechargeable battery pack is therefore to be understood to be an accumulator pack which is preferably made up of several electrically interconnected battery cells, may store electrical energy and delivers the energy for the operation of the hand-held power tool, and is exchangeably accommodated in a chamber, an interface, or the like of the hand-held power tool.

The charging of the rechargeable battery pack normally takes place via a coupling of the rechargeable battery pack to a charging device, so that electrical energy may be transmitted via cables and conductors. Alternatively, the charging is also possible via wireless and cable-free energy transmission, the technology generally being based on near-field transmission. This relates, in particular, to the coupling with the aid of magnetic induction (MI), magnetic resonance (MR), and capacitive fields. In the case of inductive coupling with the aid of magnetic induction, the energy is transmitted from the energy transmitter, the primary coil, to the energy receiver, the secondary coil, via magnetic fields. According to this principle, an HF alternating current having a frequency from 100 kHz to 205 kHz in the primary coil generates a magnetic field which is induced into the secondary coil and, there, generates an induction voltage.

With respect to the rechargeable battery packs, it proves to be disadvantageous that charging temperature ranges specified by the cell manufacturer must be observed in order to avoid damage to the rechargeable battery cell and/or the rechargeable battery block. This is to be observed, in particular, in the case of rechargeable battery packs encompassing lithium-based rechargeable battery cells. For the user or customer of the hand-held power tool, this may mean, however, that a desirable charging process must not be started or must be started only with great delay and/or must be terminated early, whereby a minimum charge level necessary for the operation may possibly not be reached, whereby, in turn, the operation of the hand-held power tool is not ensured and a necessary work interruption may occur.

In addition, the charging of the rechargeable battery pack takes place increasingly frequently while underway and leaves the typical areas, such as the workshop or the like and, therefore, the charging must take place under greatly varying temperature influences. Primarily during charging in motor vehicles, particularly difficult climatic conditions are to be expected, since the charging temperature ranges specified by the cell manufacturer cannot be observed when ambient temperatures are too low, so that the rechargeable battery packs to be charged must first be removed from the motor vehicle and heated up in warmer surroundings.

### SUMMARY

One object of the present invention is to improve the aforementioned disadvantages and provide a hand-held power tool system having an optimized charging process, which is cost-effectively and simply designed.

This object may be achieved by an example hand-held power tool system in accordance with the present invention. Advantageous embodiments, variants, and refinements of the present invention are described herein.

According to an example embodiment of the present invention, it is provided that a hand-held power tool system encompasses a hand-held power tool, a rechargeable battery pack, a charging device, at least one temperature sensor, at least one interface for electrically and/or mechanically coupling the charging device to the rechargeable battery pack to be charged, and a control unit for controlling the charging process; the charging device is suitable for charging the rechargeable battery pack of the hand-held power tool and encompasses a charging electronics system. According to the present invention, it is provided that the hand-held power tool system also encompasses at least one heating element for heating the charging device and/or the rechargeable battery pack, and the control unit is configured for receiving at least one temperature signal of the temperature sensor. In this case, the temperature signal represents a temperature of the charging device and/or of the rechargeable battery pack and/or of rechargeable battery cells in the rechargeable battery pack. Moreover, the control unit is configured for comparing the transmitted temperature to a predefined threshold value and for heating the charging device and/or the rechargeable battery pack before the start of the charging process with the aid of the heating element when the temperature transmitted via the temperature signal is below the predefined threshold value. As a result, the entire surroundings of the hand-held power tool system, the charging device, and/or the rechargeable battery pack, and/or the rechargeable battery cells in the rechargeable battery pack are/is heated.

Advantageously, the charging device is an inductive charging device for contactless and/or wireless energy transmission. In this case, it is advantageous when the charging device encompasses at least one induction coil which is designed as a primary coil and is provided for generating, in at least one operating state, a magnetic field with the aid of applied electrical energy, in particular with the aid of an AC voltage, and the magnetic field generates, in at least one inductive coil of the rechargeable battery pack designed as a secondary coil, an induced AC voltage which is utilized, after rectification, for charging the rechargeable battery pack. In principle, the primary coil is provided for converting an electromagnetic alternating field into an electric AC current and/or vice versa. In this case, it is advantageous when the alternating field has a frequency from 10 kHZ to 500 kHz, particularly preferably from 100 kHz to 150 kHz. In principle, different hand-held power tools including different rechargeable battery packs require different charge voltages, so that the primary and secondary coils must be adapted to the particular devices.

In one preferred specific embodiment, the control unit is configured for comparing the transmitted temperature to the predefined threshold value when a charging process is demanded by a user.

Moreover, in one particularly preferred specific embodiment, the control unit is configured for heating the heating element up to a previously defined optimal charging temperature, the optimal charging temperature preferably being greater than or equal to the predefined threshold value. Therefore, the charging process is started as soon as the temperature of the rechargeable battery cells is in a permissible charging temperature range. Therefore, the waiting time up to the reuse of the rechargeable battery pack may be considerably reduced with the aid of the heating process. In addition, the rechargeable batteries do not need to be removed from the vehicle in order to heat them in another way.

It has proven particularly advantageous that the control unit is configured for outputting a signal and/or starting the charging process once the previously defined optimal charging temperature has been reached.

Preferably, the heat output of the heating element is between 0.2 watts and 20 watts, advantageously between 0.5 watts and 15 watts, particularly preferably between 2 watts and 10 watts, in particular preferably between 5 watts and 10 watts.

Advantageously, the control unit is designed in such a way that, once the defined optimal charging temperature has been reached, the charging process starts only when a charging capacity of the rechargeable battery pack falls below a predetermined limiting value.

In one preferred specific embodiment, the control unit is configured for receiving at least one first temperature signal and/or one second temperature signal via the interface. It has proven advantageous that the first temperature signal is suitable for transmitting the temperature of the rechargeable battery pack and/or the temperature of the rechargeable battery cells in the rechargeable battery pack and that the second temperature signal is suitable for transmitting the temperature of the charging device.

In one particularly preferred specific embodiment, at least one contact element of the interface encompasses the at least one temperature sensor.

According to the present invention, it is particularly advantageous when the heating element is designed as an electric heating element and is preferably formed from a coil utilized in the charging electronics system of the charging device, particularly preferably from an energy-emitting primary coil. In this case, a voltage essentially of a DC nature is applied to the primary winding, whereby a power loss sets in, with the aid of which the entire hand-held power tool system and, therefore, the rechargeable battery pack as well, may be heated. This embodiment is particularly advantageous since, on the one hand, it utilizes the already present primary coil for heating and, on the other hand, the primary coil is always positioned opposite the secondary coil of the rechargeable battery pack, whereby a directed and direct heat transfer may take place. Therefore, a cost savings and a faster warm-up phase set in due to the better coupling and the better directed heat exchange. In this case, it has proven advantageous that the control unit is configured for supplying DC voltage to the coil, which is utilized as a heating element, via a relay and electrically connecting the coil to a local ground. In so doing, the heating element is supplied with energy for at least as long as the battery cells are too cold or the charging system is too cold.

In one alternative specific embodiment, at least one heating element, preferably two heating elements and/or a separate heating electronics system is/are situated within the rechargeable battery pack, the control unit or the heating electronics system being configured for supplying the at least one heating element, preferably all utilized heating elements of the rechargeable battery pack, with current via the charging device.

In general, a hand-held power tool within the scope of the application is to be understood to be all hand-held power tools including a tool carrier, which may be set into rotation or translation and which is directly drivable by a drive motor via a gear or a planetary gear set, such as, for example, a drilling machine, a hammer drill and/or percussion hammer, a saw, a planer, a screwdriver, milling cutter, a grinder, an angle grinder, a gardening device, in particular a mower, a vacuum, and/or a multi-function tool. In this context, “transmission of electrical energy” is to be understood, in particular, to mean that the hand-held power tool is supplied with energy via the rechargeable battery pack.

Preferably, rechargeable battery cells having a cell chemistry which provides a high power density and/or energy density are suitable for supplying energy to the hand-held power tool. In principle, lead rechargeable battery cells, NiCd rechargeable battery cells, NiMH rechargeable battery cells, in particular, however, lithium ion cells, may be utilized as rechargeable battery cells. The rechargeable battery cells may be formed from rechargeable battery cells having different nominal voltages, for example, nominal voltages of 1.2 V, 1.5 V or, advantageously, approximately 3.6 V. Preferably the rechargeable battery cells have a cylindrical shape, other shapes appearing meaningful to those skilled in the art being possible. Advantageously, the rechargeable battery pack encompasses multiple rechargeable battery cells, for example, at least two, three, four, five or ten. The rechargeable battery cells are connected in parallel and/or in series. In particular, in the case of lithium ion cells, it is possible to combine multiple rechargeable battery cells to form rechargeable battery cell blocks, in which multiple rechargeable battery cells are connected in a parallel circuit. In this case, it is particularly advantageous that the cell holder may accommodate rechargeable battery cells having different diameters and lengths, whereby the application of the cell holder or the cell carrier in different rechargeable battery packs may be achieved. It is also conceivable that the rechargeable battery pack is also implemented as a fuel cell, a capacitor, or as any other type of energy store appearing meaningful to those skilled in the art, or as a combination/plurality thereof.

A “rechargeable battery pack” is to be understood in this context, in particular, as an energy storage unit, in particular an energy storage unit designed as an inductively-charged rechargeable battery pack, which encompasses at least one induction coil designed as a secondary coil.

An inductive charging unit is to be understood to be a unit for charging the rechargeable battery cells, which receives a charging amperage via induction and encompasses at least the inductive charging coil and, advantageously, an inductive charging electronics system. Preferably, the inductively charging unit also encompasses at least one coil core for increasing an inductance of the at least one inductive charging coil.

A coil core is to be understood to be, in this context, in particular a means which is provided for bundling an electromagnetic field. In particular, the coil core is formed at least essentially from a magnetic material, in particular a ferromagnetic material, in particular a soft magnetic material.

An inductive charging coil is to be understood to be, in this context, in particular, a coil encompassing at least one winding made of an electrically conductive material, which is provided for receiving, in at least one operating state, electrical energy which is emitted during a charging process from an inductive charging coil of an inductive charging device and feeding the electrical energy to a rechargeable battery cell via the charging electronics system. In particular, the inductive charging coil is provided for converting an electromagnetic alternating field into an electric AC current and/or vice versa. Preferably, the alternating field has a frequency from 10 kHz to 500 kHz, particularly preferably from 100 kHz to 150 kHz.

Preferably, the inductive charging coil is designed as a wound coil; alternatively, the coil could be designed as a coil mounted on a circuit board. In particular, a charging process is to be understood as a process in which energy is inductively transmitted from an inductive charging device 700 to the rechargeable battery pack.

Further features, possible applications, and advantages of the present invention result from the description below of exemplary embodiments of the present invention, which are represented in the figures. It should be noted that the represented features merely have a descriptive character and may also be used in combination with features of other above-described refinements and are not intended to restrict the present invention in any way.

### BRIEF DESCRIPTION OF THE DRAWINGS

The present invention is explained in greater detail below with reference to preferred exemplary embodiments, identical reference numerals being used for identical features. The figures are schematic.

FIG. 1 shows a view of a hand-held power tool including an inserted rechargeable battery pack, by way of example.

FIG. 2 shows a perspective representation of a charging device.

FIG. 3 shows a perspective representation of a rechargeable battery pack.

FIG. 4 shows a side view of a first specific embodiment of a rechargeable battery pack which may be utilized in a hand-held power tool system according to the present invention.

FIG. 5 shows a side view of a second specific embodiment of a rechargeable battery pack which may be utilized in a hand-held power tool system according to the present invention.

FIG. 6 shows a top view of a third specific embodiment of a rechargeable battery pack which may be utilized in a hand-held power tool system according to the present invention.

FIG. 7 shows a detail of a block diagram of one possible specific embodiment of a charging electronics system of an inductive charging device which may be utilized in a hand-held power tool system according to the present invention.

### DETAILED DESCRIPTION OF EXAMPLE EMBODIMENTS

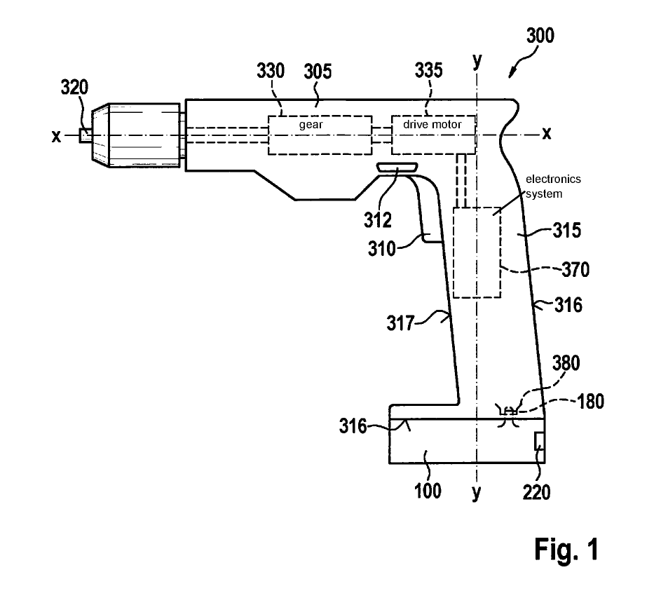

FIG. 1 shows an electrical device, which is configured as hand-held power tool 300, which is configured as a cordless combi drill, by way of example. In the represented specific embodiment, hand-held power tool 300 is therefore mechanically and electrically connected to a rechargeable battery pack 100 for battery-supplied power. It is pointed out, however, that the present invention is not restricted to cordless combi drills, but rather may be utilized with different hand-held power tools 300. Hand-held power tool 300 includes a gear 330 situated in a housing 305 for transmitting a torque generated by a drive motor 335 to a drive shaft, which is rotating about an axis x and on which a tool holder 320 for a tool (not depicted) is fastened, and includes a handle 315. An electronics system 370 is situated within housing 305 and is in electronic and/or mechanical contact with drive motor 335 and/or gear 330. Handle 315 is utilized as a support surface for a hand of an operator of hand-held power tool 300 and generally has a longitudinal axis y, a front side 317, which faces in the direction of tool holder 320 along an axis x, a back side 316, and two lateral faces 318.

A first operating element 310 for the energy supply of drive motor 335 is situated in the area of handle 315, first operating element 310 protruding from housing 305 to be manually accessible by the user, so that a control and/or regulation of the drive motor may be made possible preferably as a function of the displacement path of first operating element 310 in a way which is known per se by way of a pushing movement of first operating element 310, and the voltage supply for drive motor 335 may also be switched on and/or off. Furthermore, hand-held power tool 300 includes a second operating element 312 in the form of a slide switch for setting the direction of rotation of drive motor 335 of hand-held power tool 300. Second operating element 312 is movably situated perpendicular to rotational axis x of the drive shaft, in particular of tool holder 320 of hand-held power tool 300, so that second operating element 312, upon actuation, may be moved back and forth between a first position, a second position, and a third position. In this case, the first and the second positions each establish a direction of rotation of the drive motor. The user of hand-held power tool 300 may therefore recognize in which work mode hand-held power tool 300 is operating based simply on the positions of second operating element 312. In addition, the second switch element includes a third position between the first position and the second position, for example, a middle position, an electrical, electromechanical, and/or mechanical interruption of the motor current taking place in the third position. In this way, for example, the operation of first switch element 310 may be mechanically blocked, second operating element 312 acting upon first switch element 310 in a locking way when moved into a third position. In this case, second operating element 312 may be designed as a slide switch, as represented, or, alternatively, as a toggle switch.

First operating element 310 and second operating element 312 are situated along rotational axis x in such a way that it is possible to actuate both first and second operating elements 310, 312 using the index finger or the middle finger. In this case, the distance between first operating element 310 and second operating element 312 is selected in such a way that a single-handed operation of hand-held power tool 300 is possible. The two operating elements 310, 312 are furthermore situated in an area underneath rotational axis x and protrude from housing 305.

In the position shown in FIG. 1, rechargeable battery pack 100 is fastened on handle 315 of hand-held power tool 300 and is locked with the aid of lock. Due to the arrangement of rechargeable battery pack 100 underneath handle 315, the operation of hand-held power tool 300 is not interfered with. The lock, which are not represented in detail, include, inter alia, a locking element and an actuating element 220. By way of the actuation of actuating element 220, rechargeable battery pack 100 may be released from handle 315 of hand-held power tool 300. Furthermore, hand-held power tool 300 includes an interface 380.

Rechargeable battery pack 100 represented in FIG. 1 is designed as a sliding rechargeable battery pack, and includes an interface 180 corresponding to interface 380 of hand-held power tool 300. Alternatively to the sliding rechargeable battery pack, an embodiment as a rotary or swivel rechargeable battery pack is also possible, rechargeable battery pack 100 being releasably lockable on housing 305 of hand-held power tool 300 on the side opposite the swivel axis by latching, screwing, clamping, or bracing. In this way, the rechargeable battery pack may be effectively prevented from possibly falling off of housing 305.

For the releasable mounting of rechargeable battery pack 100 on a hand-held power tool 300 or on a charging device 700, rechargeable battery pack 100 includes an interface 180 for the releasable mechanical and electrical connection to a corresponding interface 380 of hand-held power tool 300 or a corresponding interface 780 of charging device 700. Rechargeable battery pack 100 may be assigned to hand-held power tool 300 and/or charging device 700 via interfaces 180, 380, 780.

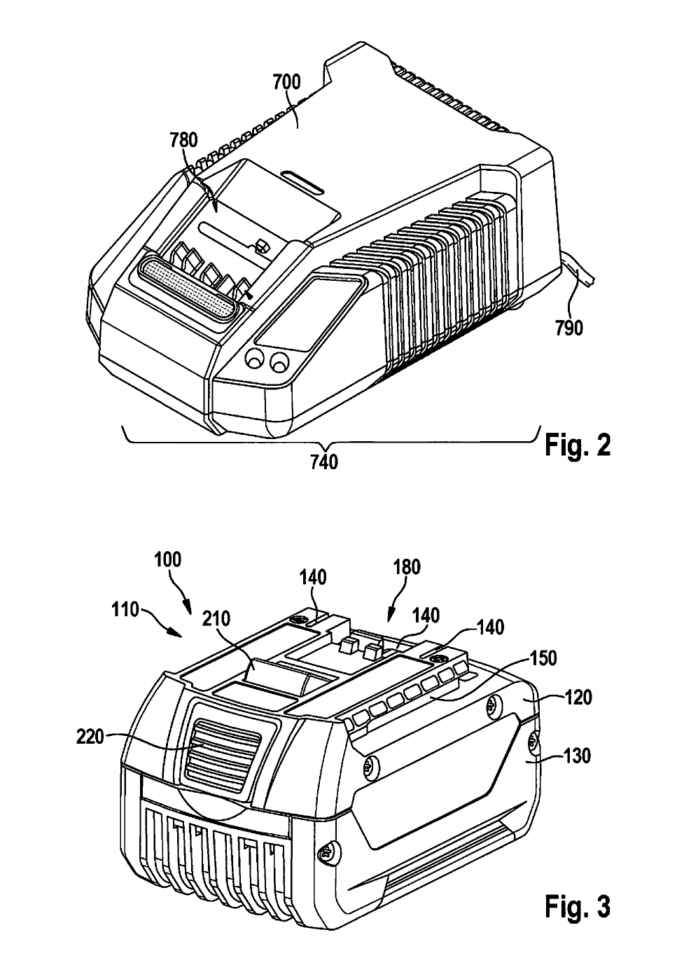

FIG. 2 shows a charging device 700. Charging device 700 is connected to the grid via a power cord 790 and encompasses a charging electronics system which is not represented here and is configured for controlling the charging process of a rechargeable battery pack 100 represented in detail in FIGS. 3 through 6.

Charging device 700 represented in FIG. 2 encompasses a charging interface 780 in order to establish a mechanical and electrical connection between charging device 700 and rechargeable battery pack 100 with the aid of a corresponding interface 180 of rechargeable battery pack 100 represented in FIG. 3. In the represented specific embodiment, charging interface 780 encompasses counter-contact elements 740 which interact with corresponding contact elements 140 of rechargeable battery pack 100 in order to transmit charging current and exchange information between charging device 700 and rechargeable battery pack 100. In this case, a specific function, which is established and is not changeable, is assigned to each of the counter-contact elements 740. This specific function may be, for example, the transmission of a predefined piece of information in the form of a signal transmitted by a corresponding contact element of the rechargeable battery pack 100 or the contacting of an established electrical pole of rechargeable battery pack 100 during the charging process.

FIGS. 3 through 6 show various possible specific embodiments of a rechargeable battery pack 100 which may be utilized in the hand-held power tool system according to the present invention. The rechargeable battery pack includes a housing 110 which encompasses, for example, a first housing component 120 and a second housing component 130, as represented in FIG. 3. Within housing 110, rechargeable battery pack 100 accommodates at least one, preferably a plurality, as represented here, of parallel- or series-connected rechargeable battery cells 400. At least in the embodiment variant represented in FIG. 3, rechargeable battery pack 100 is designed as a sliding rechargeable battery pack.

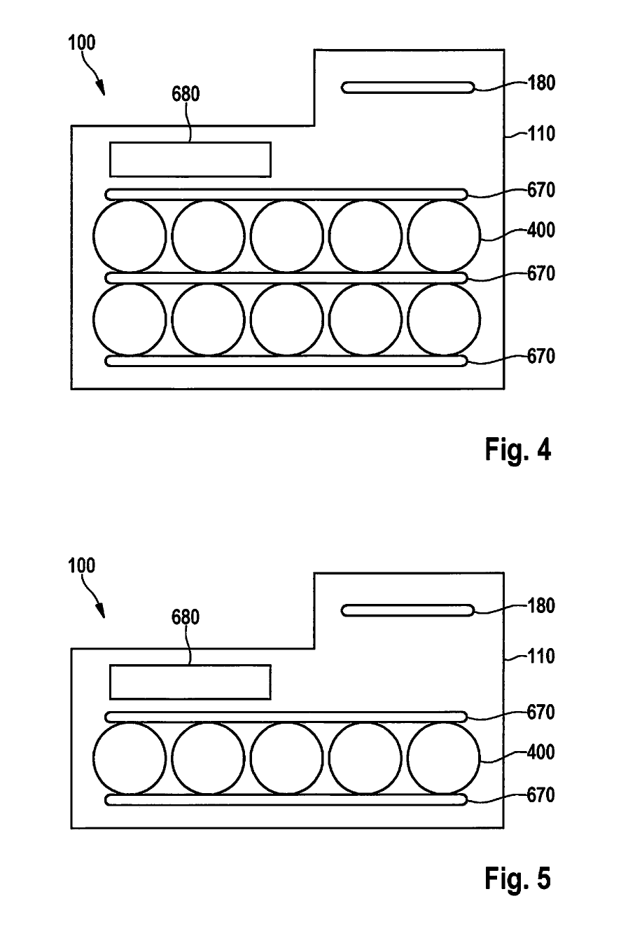

The specific embodiment of a rechargeable battery pack 100 represented in FIG. 4 encompasses ten rechargeable battery cells 400 which are situated in two layers of five rechargeable battery cells 400 each. Moreover, the rechargeable battery pack encompasses three heating elements 670 and a heating control unit 680. One heating element 670 is situated above and one heating element 670 is situated beneath rechargeable battery cells 400 in each case and a third heating element 670 is situated horizontally between the two layers of rechargeable battery cells 400.

The specific embodiment of a rechargeable battery pack 100 represented in FIG. 5, however, encompasses only one layer including five rechargeable battery cells 400, so that one heating element 670 is situated above rechargeable battery cells 400 and one heating element 670 is situated beneath the rechargeable battery cells.

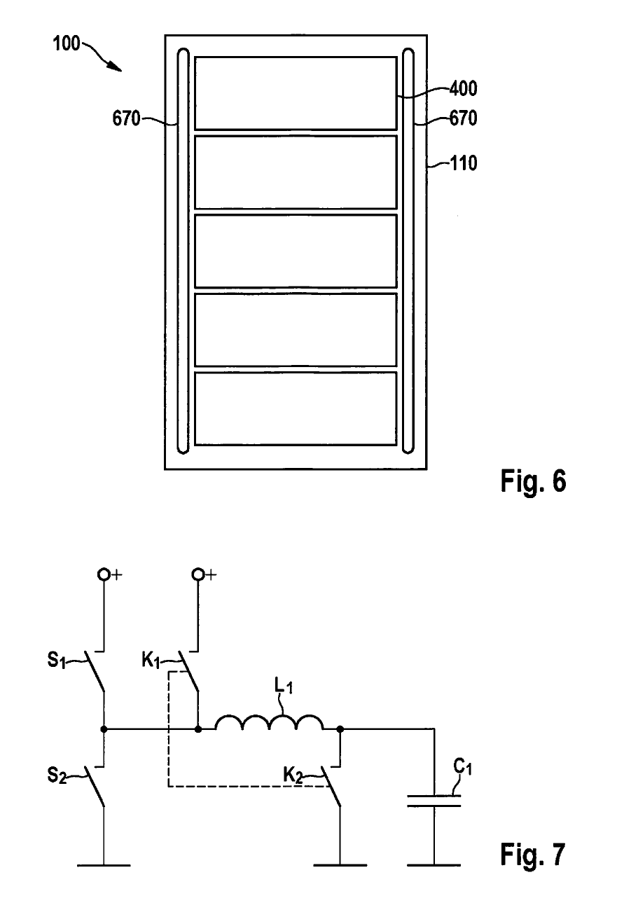

FIG. 6 shows one further specific embodiment of a rechargeable battery pack 100 in a top view, it being apparent that one heating element 670 is situated laterally with respect to rechargeable battery cells 400 in each case.

In principle, it is advantageous in all specific embodiments of rechargeable battery pack 100 encompassing a heating element 670 that the control unit or heating electronics system 680 is configured for supplying utilized heating elements 670 with current via charging device 700 and not via rechargeable battery cells 400.

It is not represented in detail, but is advantageous, in principle, that the control unit is configured for receiving a first temperature signal and/or a second temperature signal via the interface and/or at least one contact element of the interface directly forms a temperature sensor.

FIG. 7 shows a block diagram of an inductive charging device 700 which may be utilized in a hand-held power tool system according to the present invention for contactless and/or wireless energy transmission. In the block diagram of the charging electronics system of inductive charging device 700, heating element 670 is designed in the form of a primary coil L1. Those skilled in the art directly ascertain from this diagram that capacitor C1, two switches S1 and S2, and relay K1 interact in such a way that primary coil L1 is supplied with current as necessary, in order to induce the heating effect of primary coil L1. If this is the case, primary coil L1 is connected via relay K1 to a DC voltage, and to the local ground.

In this case, capacitor C1 is bridged. Moreover, S1 and S2 are switching elements of the half-bridge; no further explanation is required for those skilled in the art with respect to the present invention.

The heat output of the heating element is in the range between 0.2 watts and 20 watts, advantageously between 0.5 watts and 15 watts, particularly preferably between 2 watts and 10 watts, in particular preferably between 5 watts and 10 watts. In this case, the control unit of the hand-held power tool system is designed in such a way that, once the defined optimal charging temperature has been reached, the charging process starts only when a charging capacity of rechargeable battery pack 100 falls below a predetermined limiting value.

In one alternative specific embodiment which is not represented in detail, it would also be possible to switch the arrangement of L1 and C1, where a bridging of C1 would no longer be necessary in this case due to the ground reference of L1.

In addition to the described and illustrated specific embodiments, further specific embodiments are conceivable, which may include further modifications and combinations of features.

1-15. (canceled)

16. A hand-held power tool system, comprising:
a hand-held power tool;
a rechargeable battery pack;
a charging device configured to charge the rechargeable battery pack of the hand-held power tool and including a charging electronics system;
at least one temperature sensor;
at least one interface configured to electrically and/or mechanically couple the charging device to an interface of the rechargeable battery pack to be charged; and
a control unit configured to control a charging process; and
at least one heating element configured to heat the charging device and/or the rechargeable battery pack;
wherein the control unit is configured to receive at least one temperature signal of the temperature sensor, the temperature signal representing a temperature of the charging device and/or of the rechargeable battery pack and/or of rechargeable battery cells in the rechargeable battery pack, the control unit being further configured to compare the temperature received via the temperature signal to a predefined threshold value and to heat the charging device and/or the rechargeable battery pack before a start of the charging process using the heating element when the temperature received via the temperature signal is below the predefined threshold value.

17. The hand-held power tool system as recited in claim 16, wherein the charging device is an inductive charging device configured for contactless and/or wireless energy transmission.

18. The hand-held power tool system as recited in claim 16, wherein the control unit is configured to compare the temperature received via the temperature signal to the predefined threshold value when the charging process is demanded by a user.

19. The hand-held power tool system as recited in claim 16, wherein the control unit is configured to heat the heating element up to a previously defined optimal charging temperature, the optimal charging temperature being greater than or equal to the predefined threshold value.

20. The hand-held power tool system as recited in claim 19, wherein the control unit is configured to output a signal and/or start the charging process once the previously defined optimal charging temperature has been reached.

21. The hand-held power tool system as recited in claim 16, wherein a heat output of the heating element is between 0.2 watts and 20 watts.

22. The hand-held power tool system as recited in claim 21, wherein the heat output is between 2 watts and 10 watts.

23. The hand-held power tool system as recited in claim 21, wherein the heat output is between 5 watts and 10 watts.

24. The hand-held power tool system as recited in claim 16, wherein the control unit is designed in such a way that, once a defined optimal charging temperature has been reached, the charging process starts only when a charging capacity of rechargeable battery pack falls below a predetermined limiting value.

25. The hand-held power tool system as recited in claim 16, wherein the control unit is configured to receive at least one first temperature signal and/or one second temperature signal via the interface.

26. The hand-held power tool system as recited in claim 25, wherein the first temperature signal is for transmitting a temperature of the rechargeable battery pack and/or a temperature of the rechargeable battery cells in the rechargeable battery pack, and that the second temperature signal is for transmitting a temperature of the charging device.

27. The hand-held power tool system as recited in claim 16, wherein at least one contact element of the interface on the charging device encompasses the at least one temperature sensor.

28. The hand-held power tool system as recited in claim 16, wherein the heating element is an electric heating element formed from a coil utilized in the charging electronics system of the charging device.

29. The hand-held power tool system as recited in claim 28, wherein the coil is an energy-emitting primary coil.

30. The hand-held power tool system as recited in claim 29, wherein the control unit is configured to supply DC voltage to the coil, which is utilized as a heating element via a relay, and to electrically connect the coil to a local ground.

31. The hand-held power tool system as recited in claim 16, wherein the at least one heating element is situated within the rechargeable battery pack.

32. The hand-held power tool system as recited in which 16, wherein a separate heating electronic system is situated within the rechargeable battery pack.

33. The hand-held power tool system as recited in claim 31, wherein the control unit or the heating electronics system is configured to supply the at least one heating element with current via the charging device.
